(19) United States
(12) Patent Application Publication
(10) Pub. No.: US 2007/0077001 A1
(43) Pub. Date: Apr. 5, 2007

(54) ELECTRO-OPTICAL MODULE, ELECTRO-OPTICAL APPARATUS, AND ELECTRONIC APPARATUS

(75) Inventor: Takaaki Hayashi, Suwa-shi, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/464,684

(22) Filed: Aug. 15, 2006

(30) Foreign Application Priority Data
Sep. 30, 2005 (JP) 2005-286410

(51) Int. Cl. G02B 6/12

(52) U.S. Cl. 385/14; 385/89

(57) ABSTRACT

An electro-optical module is provided. The electro-optical module includes an electro-optical panel provided with a light-emitting unit where a plurality of light-emitting devices are arrayed in a line shape, two wiring boards which interpose the electro-optical panel and are disposed in a direct parallel to a longitudinal direction of the electro-optical panel, a plurality of flexible boards which connect the electro-optical panel to the wiring boards, and a driving circuit which is disposed in the electro-optical panel or on the flexible boards and drives the light-emitting devices.

### BACKGROUND

1. Technical Field

The present invention relates to an electro-optical module, an electro-optical apparatus, and an electronic apparatus, and more particularly, to an electro-optical module, an electro-optical apparatus, and an electronic apparatus usefully employed in a case where light-emitting devices are arrayed in a line shape.

2. Related Art

As a printer using electro-photography, a line printer (image forming apparatus) is known. FIG. 13 is a schematic view showing a line printer in the related art. As shown in FIG. 13, the line printer 500 includes a charger 520, a line-shaped printer head (line head) 530, a developer 540, a transfer unit 550, or other devices which disposed in the vicinity of a circumferential surface of a photosensitive drum 510, that is, an to-be-exposed object. Namely, in the line printer 500, a plurality of light-emitting devices provided to the printer head 530 are allowed to selectively emit light so as to form an electrostatic latent image on the circumferential surface of the photosensitive drum 510, and the electrostatic latent image is developed by using a toner supplied from the developer 540, so that a toner image is transferred on a paper 560 by the transfer unit 550.

As described above, in the line printer 500, at least the photosensitive drum 510 is disposed, and a large number of devices including the charger 520, the printer head 530, the developer 540, and the transfer unit 550 are disposed in the vicinity of the photosensitive drum 510. Therefore, when the line printer intends to be miniaturized, there is a problem in that all the devices disposed in the vicinity of the photosensitive drum 510 are required to be miniaturized. Particularly, there is a problem in that the printer head 530 is required to be miniaturized in a circumferential direction of the photosensitive drum 510.

As a method of solving the problem, there is proposed a method of miniaturizing the printer head in the circumferential direction of the photosensitive drum by disposing driving circuits for driving the light-emitting devices at a side surface of the printer head (see JP-A-2005-137439). However, in the method, since the driving circuits are disposed on the side surface of a supporting plate formed in a concave shape, there are problems of complication in production processes and deterioration in productivity.

As another method of solving the problem, there is proposed a method of miniaturizing the printer head in the circumferential direction of the photosensitive drum by disposing the light-emitting devices and the driving circuits for driving the light-emitting devices on separated boards and separating the board on which the driving circuits are disposed from the printer head (see JP-A-2002-254700). However, since the light-emitting devices and the driving circuits are connected with long wires, there are problems of difficulty in signal controlling and deterioration in reliability

### SUMMARY

An advantage of some aspects of the invention is to provide a compact electro-optical module capable of effectively using a space by three-dimensionally mounting elements of the electro-optical module, an electro-optical apparatus having the electro-optical module, and an electronic apparatus having the electro-optical apparatus,

According to a first aspect of the invention, there is provided an electro-optical module comprising: an electro-optical panel provided with a light-emitting unit where a plurality of light-emitting devices are arrayed in a line shape; two wiring boards which interpose the electro-optical panel and are disposed in a direction parallel to a longitudinal direction of the electro-optical panel; a plurality of flexible hoards which connect the electro-optical panel to the wiring boards; and a driving circuit which is disposed in the electro-optical panel or on the flexible boards and drives the light-emitting devices.

In the first aspect, it is possible to implement a compact electro-optical module.

According to a second aspect of the invention, in the electro-optical module according to the first aspect, each of the light-emitting devices may be disposed between a port connected to each of the light-emitting devices and a common port shared by a plurality of the light-emitting devices, and the common port may be connected to a common port having the same polarity disposed on at least one wiring board.

In the second aspect, it is possible to supply a sufficient electric power to the light-emitting devices.

According to a third aspect of the invention, in the electro-optical module according to the first or second aspect, the flexible boards are divided into a plurality of the flexible boards.

In the third aspect, it is possible to accurately connect the flexible boards to the electro-optical panel and wiring boards.

According to a fourth aspect of the invention, the electro-optical module according to any one of the first to third aspects may further comprise a control board provided with a control circuit which controls the light-emitting devices through the driving circuits, wherein one end of each flexible board is bent so as for each wiring board to overlap one side surface of the flexible board, and the other end of each flexible board is bent so as for each wiring board to constitute a wall surface substantially perpendicular to the electro-optical panel in an inner side of the flexible board, and wherein the control board connecting the wiring boards is disposed between the wiring boards constituting the wall surface.

In the fourth aspect, it is possible to implement a more compact electro-optical module. In addition, it is possible to simultaneously drive the light-emitting devices based on signals simultaneously transmitted from the control board to the two wiring boards and to supply the same electric power to the light-emitting devices. In addition, it is possible to suppress influence of noise generated from the control board.

According to a fifth aspect of the invention, the electro-optical module according to the fourth aspects may further comprise a case which has a receiving portion for receiving the wiring boards, the flexible boards, and the control board, wherein the control board is provided with protrusions where an input port for inputting an external signal is disposed, and wherein openings through which the protrusions pass are provided to a bottom surface of the receiving portion of the case, and the wiring boards, the flexible boards, and the control board are received in the receiving portion in a state that the protrusions externally protrude from the openings.

In the fifth aspect, it is possible to implement a more compact electro-optical module in addition, it is possible to simultaneously drive the light-emitting devices based on signals simultaneously transmitted from the control board to the two wiring boards and to supply the same electric power to the light-emitting devices. In addition, it is possible to suppress influence of noise generated from the control board.

According to a sixth aspect of the invention, in the electro-optical module according to any one of the first to fifth aspects, the light-emitting unit may be constructed with a plurality of the light-emitting devices which are arrayed in a zigzag shape.

In the sixth aspect, it is possible to increase a density of the radiating light from the light-emitting devices.

According to a seventh aspect of the invention, in the electro-optical module according to any one of the first to sixth aspects, the wiring boards may be constructed by using a board having the same structure.

In the seventh aspect, it is possible to reduce production costs for the electro-optical module and to implement an electro-optical module capable of performing stabilized operations.

According to an eighth aspect of the invention, in the electro-optical module according to any one of the first to seventh aspects, the flexible boards may be constructed by using a board having the same structure.

In the eighth aspect, it is possible to reduce production costs for the electro-optical module and to implement an electro-optical module capable of performing stabilized operations.

According to a ninth aspect of the invention, there is provided an electro-optical apparatus including the electro-optical module according to any one of the first to eighth aspects.

In the ninth aspect, it is possible to implement a compact electro-optical apparatus.

According to a tenth aspect of the invention, in the electro-optical apparatus according to the ninth aspect, a condensing lens array may be disposed on a light-emitting surface of the light-emitting unit.

In the tenth aspect, it is possible to accurately condense the radiating light from the light-emitting devices.

According to an eleventh aspect of the invention there is provided an electronic apparatus including the electro-optical apparatus according to the ninth or tenth aspect.

In the eleventh aspect, it is possible to implement a compact electronic apparatus.

### BRIEF DESCRIPTION OF THE DRAWINGS

The invention will be described with reference to the accompanying drawings, wherein like numbers reference like elements.

FIG. 1 is a schematic top view showing an electro-optical module according to a first embodiment.

FIG. 2 is a schematic side view showing the electro-optical module as seen from a direction A shown in FIG. 1.

FIG. 3 is a schematic top view showing a portion of the electro-optical module according the first embodiment.

FIG. 4 is a schematic perspective view showing optical printer head body according to the first embodiment

FIG. 5 is a schematic side view showing the optical printer head body as seen from a direction B shown in FIG. 4.

FIG. 6 is a schematic side view showing a before-assembled state of the electro-optical module according to the first embodiment.

FIGS. 7A and 7B are schematic views showing a control board according to the first embodiment.

FIGS. 8A to 8C are schematic views showing a case according to the first embodiment.

FIG. 9 is a schematic perspective view showing the optical printer head according to the first embodiment.

FIG. 10 is a schematic ton view showing an electro-optical module according to a second embodiment.

FIG. 11 is a schematic top view showing an electro-optical module according to a third embodiment.

FIG. 12 is a schematic ton view showing an electro-optical module according to a fourth embodiment.

FIG. 13 is a schematic view showing a line printer.

### DETAILED DESCRIPTION OF EXEMPLARY EMBODIMENTS

Hereinafter, preferred embodiments of the invention will be described. The description of the embodiment is made for an example, but the invention is not limited to the description.

### First Embodiment

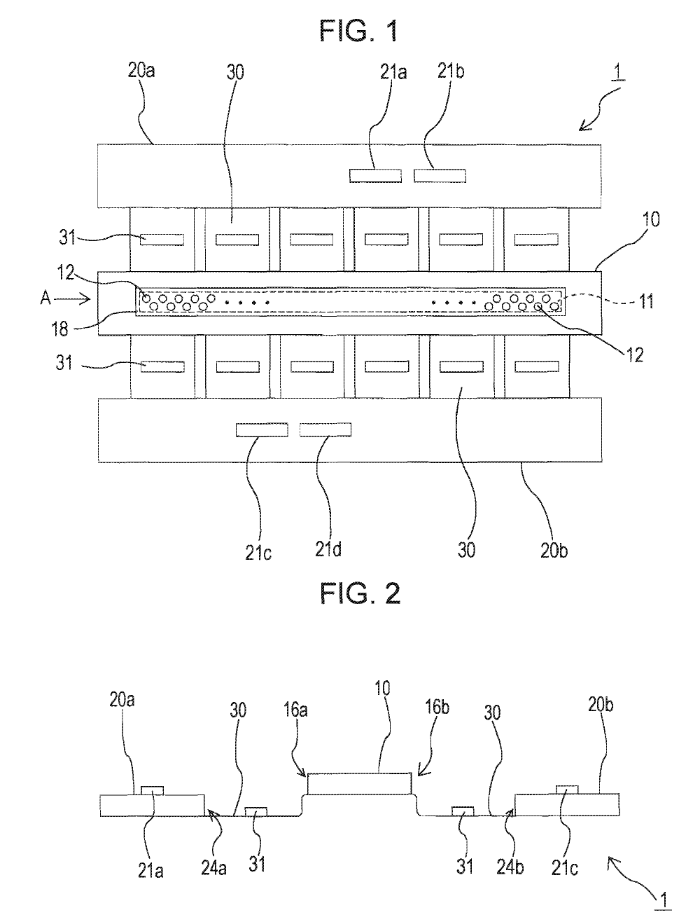

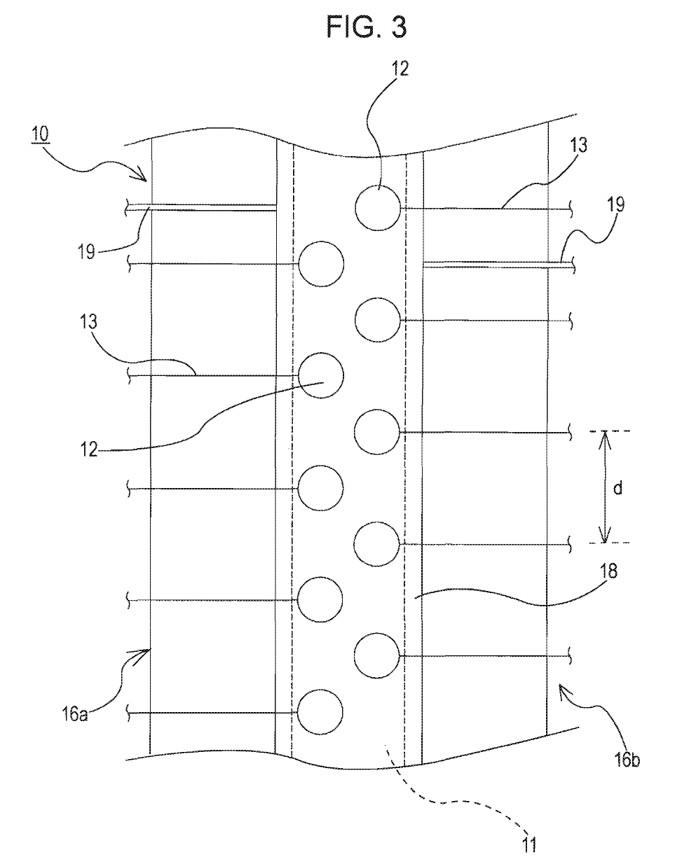

FIG. 1 is a schematic top view showing an electro-optical module according to a first embodiment. FIG. 2 is a schematic side view showing the electro-optical module as seen from a direction A shown in FIG. 1. FIG. 3 is an enlarged view showing a portion of the electro-optical module according the first embodiment. As shown in FIGS. 1 and 2, the electro-optical module 1 includes a rectangular electro-optical panel 10.

In the electro-optical panel 10, a light-emitting unit 11 where a plurality of light-emitting devices 12 are arrayed in a zigzag shape is disposed to extend in a longitudinal direction along a width-direct ion central portion of the electro-optical panel 10. In addition, as shown in FIG. 3, the electro-optical panel 10 is provided with wires 13 which are disposed between both ends of long edge sides of the electro-optical panel 10 and the light-emitting devices 12 and a transparent common port 18 which is disposed on surface of the light-emitting devices 12 over the entire region where the light-emitting devices 12 are disposed. The light-emitting devices 12 are disposed between the wires 13 and the common port 18. A plurality of ground wires 19 are connected to the common port 18 at a rate of one ground wire per a predetermined number of wires 13. When a power is supplied through the wires 13 and wires 19, the light-emitting devices 12 emit light.

As shown in FIGS. 1 and 2, at both sides of the electro-optical panel 10 in the width direction thereof, the rectangular wiring boards 20a and 20b are disposed in a direction parallel to the longitudinal direction of the electro-optical panel 10 with the electro-optical panel 10 interposed therebetween.

The wiring boards 20a and 20b are provided with connection ports 21a to 21d for signals input from a control circuit (not shown). In addition, six flexible boards 30 are disposed in parallel between the electro-optical panel 10 and the wiring board 20a, and six flexible boards 30 are disposed in parallel between the electro-optical panel 10 and the wiring board 20b.

As shown in FIG. 2, with respect to each of the six flexible boards 30 disposed between the electro-optical panel 10 the wiring board 20a, through an anisotropic conductive film, one end thereof is connected to the end portion 16a of the electro-optical panel 10 facing the wiring board 20a, and the other end thereof is connected to the end portion 24a of the wiring board 20a facing the electro-optical panel 10. Similarly, with respect to each of the six flexible boards 30 disposed between the electro-optical panel 10 the wiring board 20b, through an anisotropic conductive film, one end thereof is connected to the end portion 16b of the electro-optical panel 10 facing the wiring board 20b, and the other end thereof is connected to the end portion 24b of the wiring board 20a facing the electro-optical panel 10.

Diving circuits 31 for driving the light emitting services 12 are disposed in the flexible boards 30 to drive the light-emitting devices 12 based on the signals input from the boards 23a and 20b.

According to the electro-optical module 1 having such a construction, since the wires 13 connected to the light-emitting devices 12 disposed on the electro-optical panel 10 can be disposed on both ends 16a and 16b of the long edge side of the electro-optical panel 10, it is possible to increase an inter-wire distance between the wires 13 connected to the light-emitting devices 12. Namely, as shown in FIG. 3, the wires 13 which are connected to the light-emitting devices 12 disposed in a zigzag shape are alternately arrayed toward both ends of the electro-optical panel 10 at a long side portion, so that inter-wire distances d between the wires 13 connected to the light-emitting devices 12 can be increased.

Since the driving circuits 31 are disposed on the separate flexible boards 30, in a case where the flexible boards 30 have defects, for example, in a case where the driving circuits 31 are defective products, the defects can be easily removed by replacing the defective flexible boards 30.

Next, components constituting the electro-optical module 1 are described. If the electro-optical panel 10 includes the light-emitting unit 11 where a plurality of the light-emitting devices 12 are disposed in a line shape, and if the wires which are disposed to any one of the end portions 16a closer to the wiring boards 20a and the end portions 16b of the wiring board 20b, the electro-optical panel 10 is not particularly limited. However, as shown in FIG. 3, in a case where the wiles 13 connected to the light-emitting devices 12 are alternately disposed toward the end portion 16a facing the wiring board 20a or toward the end portion 16b facing the wiring board 20b, the inter-wire distances of the wires 13 connected to the light-emitting devices 12 can be preferably increased.

In addition, in the light-emitting unit 11 according to the embodiment, the light-emitting devices 12 are disposed in a zigzag shape in order to increase a density of the radiating light, but invention is not limited thereto. Alternatively, the light-emitting devices 12 may be arrayed in a row or in a plurality of rows. In addition, the light emitting devices are not particularly limited, but an organic EL device or an LED device is preferred.

If the lengths of the wiring boards 20a and 20b are equal to the length of the electro-optical panel 10 in the longitudinal direction, the lengths of the wiring boards 20a and 20b in the longitudinal direction are not particularly limited. In addition, in the embodiment, since the boards having the same structure are used as the wiring boards 20a and 20b, it is possible to further reduce production cost. In addition, since the wiring boards 20a and 20b can be formed by using a board having the same structure, a deviation between an electric power supplied through the wiring board 20a and an electric power supplied through the wiring board 20b and a deviation between a signal transmitted through the wiring board 20a and a signal transmitted through the wiring board 20b are lowered, it is possible to implement an electro-optical module 1 capable of performing stabilized operations.

If a distance between the end portion connected to the electro-optical panel 10 and the end portions connected to the wiring boards 20a and 20b is longer than width direction lengths of the wiring boards 20a and 20b, and if the driving circuits can be disposed therein, the flexible boards 30 are not particularly limited. In addition, in the embodiment, since the boards having the same structure are used as the flexible boards 30, it is possible to further reduce production cost. In addition, in the embodiment, since the electro-optical panel 10 and the wiring boards 20a and 20b are connected to the both sides of the end portions of the long edge sides of the electro-optical panel 10 through a plurality of the flexible boards 30, it is possible to accurately connect the flexible boards 30 to the electro-optical panel 10 and the wiring boards 10a and 20b. Therefore, it is possible to manufacture the electro-optical module 1 having a high accuracy. In addition, the number of the flexible boards 30 connecting the electro-optical panel 10 to the wiring boards 20a and 20b is not particularly limited.

By using the aforementioned electro-optical module 1, it is possible to implement a more compact electro-optical apparatus and electronic apparatus. Hereinafter, a optical printer head is described as an example of the electro-optical apparatus employing the electro-optical module 1 according to the embodiment.

Optical Printer Head

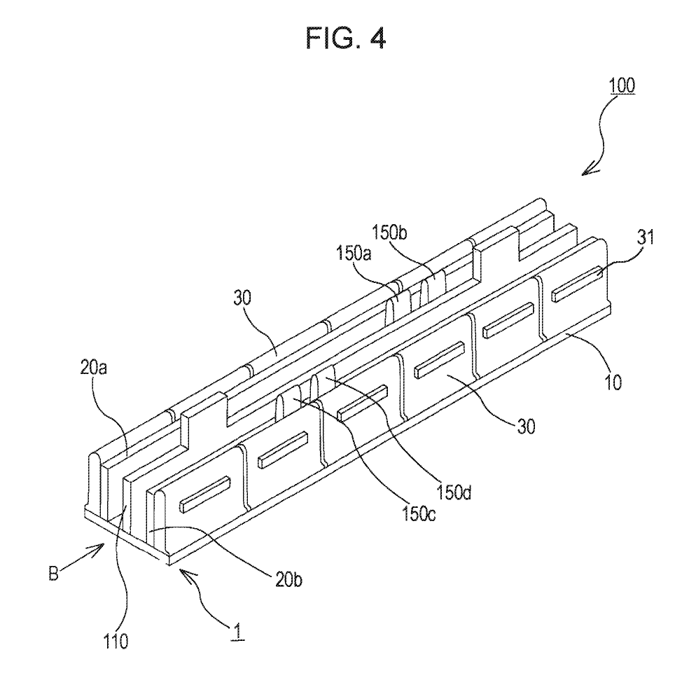

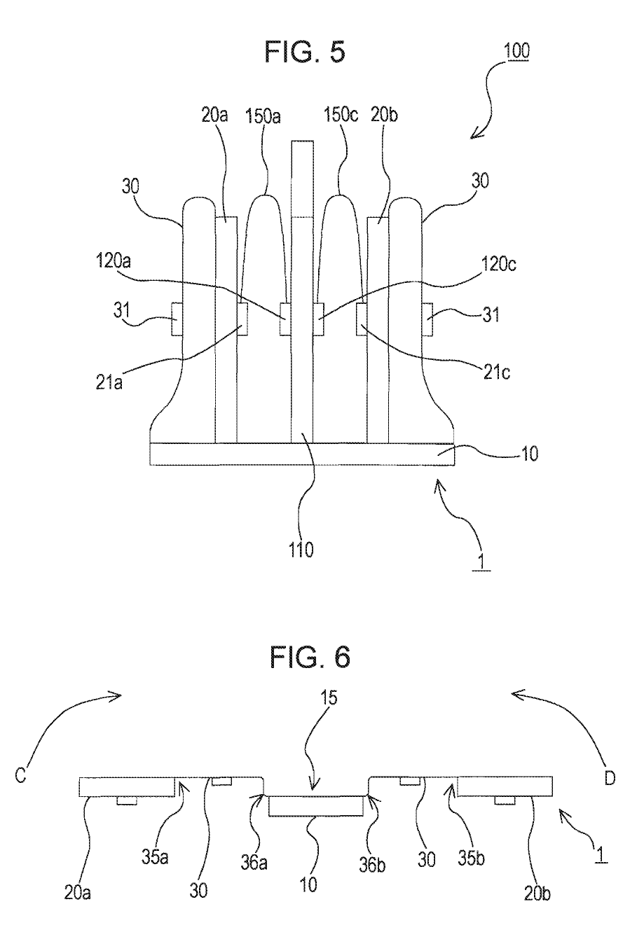

FIG. 5 is a schematic perspective view showing a optical printer head body constituting the optical printer head employing the electro-optical module 1 according to the embodiment. FIG. 5 is a schematic side view showing the optical printer head body as seen from a direction B shown in FIG. 4. As shown in FIGS. 4 and 5, the optical printer head body 100 is constructed by using the electro-optical module 1 and the control board 11. More specifically, the optical printer head body 100 is assembled as follows.

FIG. 6 is a schematic side view showing as a before-assembled state of the electro-optical module according to the embodiment. Firstly, the one end of each flexible board 30 connected to wiring board 20a is bent in a direction C shown in FIG. 6, so that the wiring boards 20a overlap with surfaces of the flexible boards 30. Next, in a state that the wiring boards 20a overlap with the surfaces of the flexible boards 30, the other end of each flexible boards 30 is further bent in the direction C shown in FIG. 6, so that the wiring boards 20a are formed as wall surfaces perpendicular to the electro-optical panel 10.

Similarly, the one end 35b of each flexible boards 30 connected to the wiring boards 20b is bent in a direction B shown in FIG. 6, so that the wiring boards 20b overlap with the surfaces of the flexible boards 30. Next, in a state that the wiring boards 20b overlap with the surfaces of the flexible boards 30, the other end of each flexible boards 30 is further bent in the direction D shown in FIG. 6, so that the wiring boards 20b are formed as wall surfaces perpendicular to the electro-optical panel 10.

In addition, the rectangular control board 110 is disposed between the wiring board 20a and the wiring board 20b of the electro-optical module 1, and the control board 110 is connected to the wiring boards 20a and 20b, so that the optical printer body 100 is assembled.

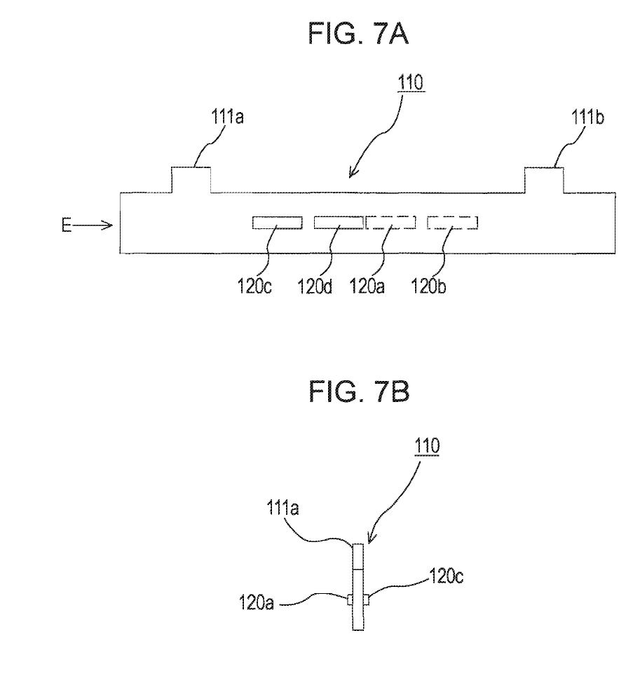

Next, the control board 110 is described. FIG. 7A is a schematic top view of the control board 110, and FIG. 7B is a schematic side view of the control board 110 as seen from a direction E shown in FIG. 7A. As shown in FIG. 7A, in the control board 110, protrusions 111a and 111b protruding in a width direction of the control board are disposed at both ends of the control board 100 in a longitudinal direction thereof. In addition, the protrusions 111a and 111b are provided with input ports (not shown) for connection to an external printer body. In addition, the control board 110 is provided with connection ports 120a to 120d. As shown in FIG. 4, the connection ports 120a to 120d are connected to the connection ports 21a to 21d of the wiring boards 20a and 20b through the flexible flat cables (FFC) 150a to 150d, respectively, so that the control board 110 and the wiring boards 20a and 20b can be connected to each other. Namely, as shown in FIG. 7B, since the connection ports 120a and 120b are disposed on one surface of the control board 110, the connection ports 120a and 120b are connected to the connection ports 21a and 21b of the wiring board 20a through the FFCs 150a and 150b, respectively, so that the control board 110 and the wiring board 20a can be connected to each other. Similarly, since the connection ports 120c and 120d are disposed on the other surface of the control board 110, the connection ports 120c and 120d are connected to the connection ports 21c and 21d of the wiring board 20b through the FFCs 150c and 150d, respectively, so that the control board 110 and the wiring board 20b can be connected to each other. In addition, although two protrusions 111a and 111b are provided to the control board 110 in the embodiment, the number of the protrusions is not limited thereto.

If the flexible flat cables (FFC) 150a to 150d can connect the control board 110 to the wiring boards 20a and 20b, the flexible flat cables (FFC) 150a to 150d are not particularly limited.

Next, a case is attached to the optical printer head body 100 having such a construction so as to receive the wiring boards 20a and 20b, the flexible boards 30, and the control board 110, so that the optical printer head is constructed.

In addition, in the embodiment, the wiring boards 20a and 20b are formed as the wall surfaces perpendicular to the electro-optical panel 10. But, the wiring boards may not necessarily be formed as the wall surfaces perpendicular to the electro-optical panel 10. For example, the wiring boards 20a and 20b may be formed as the wall surfaces having an acute angle with respect to the electro-optical panel 10, that is, the wall surfaces which are formed by further bending the flexible boards 30 connected to the wiring boards 20a and 20b in the direction C or D.

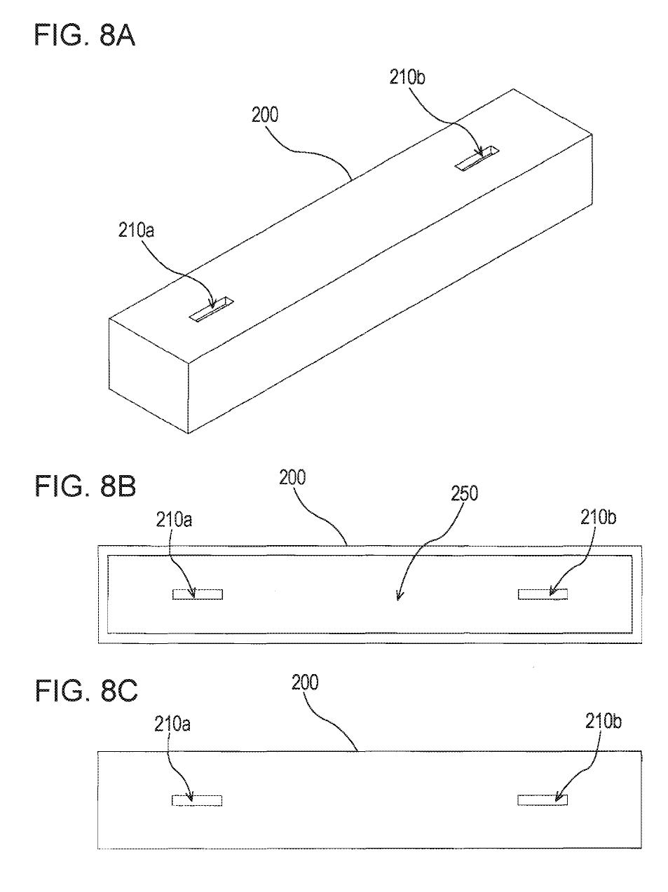

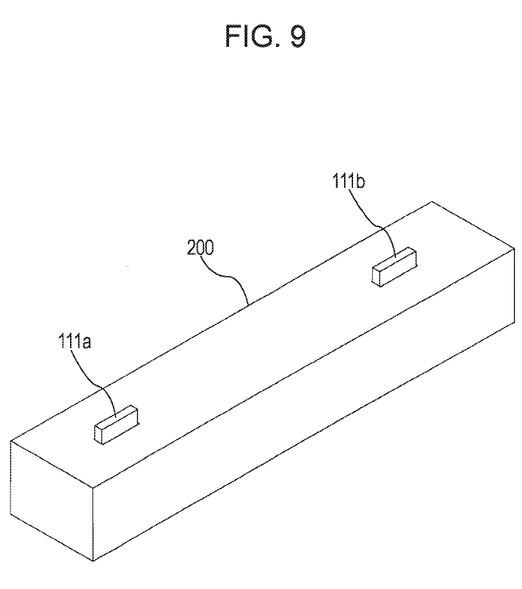

Next, the case is described. FIG. 8A is a schematic perspective view of the case, FIG. 8B is a schematic bottom view, and FIG. 8C is a schematic top view. As shown in FIGS. 8A to 8C, the case 200 is provided with a receiving portion 250 to receive the wiring boards 20a and 20b, the flexible boards 30, and the control board 110 of the optical printer head body 100. The openings 213a and 210b are provided to a bottom surface of the receiving portion 250 of the case 200, and as shown in FIG. 9, the protrusions 111a and 111b of the control board 110 protrude from the case 200 through the openings 210a and 210b in a state that the wiring boards 20a and 20b, the flexible boards 30, and the control board 113 are received in the receiving portion 250 of the case 200. According to the construction, it is possible to easily connect the optical printer head according to the embodiment to the printer body.

If the case 200 can receives the wiring boards 20a and 20b, the flexible boards 30, and the control board 110 of the optical printer head body 100, the case is not particularly limited. It is preferable that the case 200 is made of a metal, because an influence of noise generated from an inner portion of the case 290 can be suppressed.

By constructing the optical printer head using the electro-optical module 1, it is possible to obtain a more compact optical printer head. Namely, as described above, in the electro-optical module 1, a space can be effectively used by three-dimensionally mounting the wiring boards 20a and 20b, so that it is possible to increase areas of the wiring boards without changing the width of the electro-optical panel 10. Therefore, in comparison with a optical printer head having such functions in the related art, it is possible to implement a compact optical printer head

In addition, the optical printer head such a construction, since the wiring board 20a and the flexible boards 30 and the wiring board 20b and the flexible boards 30 are disposed in a surface symmetric manner with respect to the control board 110, it is possible to simultaneously drive the light-emitting devices based on signals simultaneously transmitted from the control board 110 to the wiring board 20a and the wiring board 20b and to supply the same electric power to the light-emitting devices. Namely, since the wires formed from the control board 110 through the wiring board 20a and the flexible boards 30 to the light-emitting devices are the same as the wires formed from the control board 110 through the wiring board 20b and the flexible boards 30 to the light-emitting devices, it is possible to simultaneously drive the light-emitting devices based on the signals simultaneously transmitted from the control board 110 to the wiring board 20 without any synchronization and the wiring board 20b and to supply the same electric power to the light-emitting devices.

In addition, when the electro-optical module 1 in the optical printer head is out of order, only the electro-optical module 1 can be replaced without replacement of the control board 110, it is possible to easily solve the problem.

In addition, in the optical printer head, since the wiring boards 20a and 20b are disposed in parallel to each other with the control board interposed there between, an influence of the noise generated from the control board can be suppressed. In addition, when grand wires are further provided to the wiring boards 20a and 20b, an influence of the noise generated from the control board can be further suppressed.

In addition, as described above, in the optical printer head, since the electro-optical module 1 having a high accuracy is can be used, it is possible to easily receive the optical printer head body 100 in the receiving portion 250 of the case 200.

In addition, in the optical printer head, since the connection ports 21a to 21d of the wiring boards 20a and 20b are disposed on non-central portions of the wiring boards 20a and 20b in the longitudinal direction thereof, and since the corresponding connection ports 120a and 120b of the control board 110 are disposed on non-central portion of the control board 110 in the longitudinal direction, it is possible to easily connect the wiring boards 20a and 20b of the control board 110.

In addition, a condensing lens array may be disposed on surface of the light-emitting unit 11 of the optical printer head. By disposing the condensing lens array on the surface of the light-emitting unit 11, it is possible to focus the light radiating from the light emitting unit 11 with a high accuracy.

### Second Embodiment

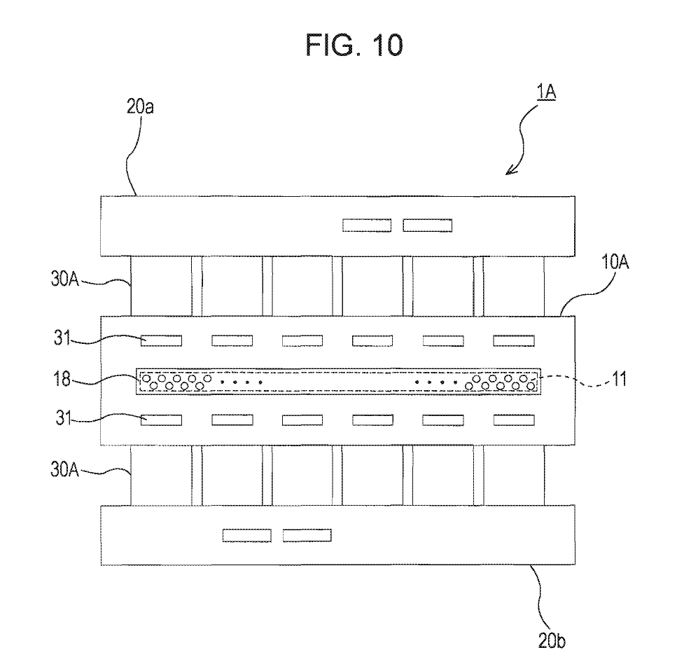

In the first embodiment, the driving circuits 31 of the electro-optical module 1 are disposed to the flexible boards 30, respectively. However, as shown in FIG. 10, the driving circuits 31 may be disposed on an electro-optical panel 10A. According to the electro-optical module 1A such a construction, it is possible to simplify flexible boards 30A.

The electro-optical panel 10A is equal to the electro-optical module 1 according to the first embodiment except for the arrangement of the driving circuits 31A.

Flexible boards 30A is formed by removing the driving circuits 31 from the flexible boards 30 according to the first embodiment so as to simplify wiring. Since other elements are the same as those of the aforementioned electro-optical module 1, the elements are denoted by the same reference numerals, and the description thereof is omitted.

### Third Embodiment

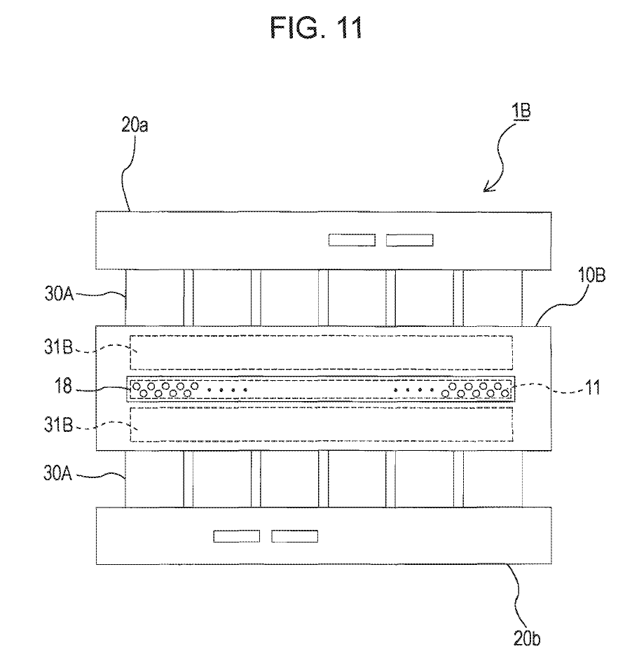

In the first and second embodiments, the driving circuits are disposed on the flexible boards or the electro-optical panel. However, as shown in FIG. 11, driving circuits 31B may be directly formed on an electro-optical panel 10B. More specifically, TFT (Thin Film Transistor) circuits or the like may be formed on the electro-optical panel 10B. According the electro-optical module 1B having such a construction, it is possible to obtain a more compact electro-optical module.

The electro-optical panel 10B is equal to the electro-optical module 10A according to the second embodiment except for the direct format ion of the driving circuits 31B. Since other elements are the same as those of the aforementioned electro-optical module 1A, the elements are denoted by the same reference numerals, and the description thereof is omitted.

### Fourth Embodiment

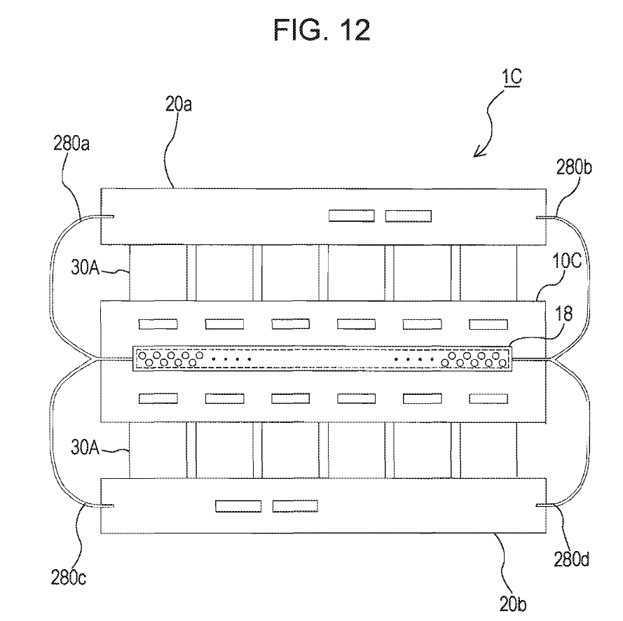

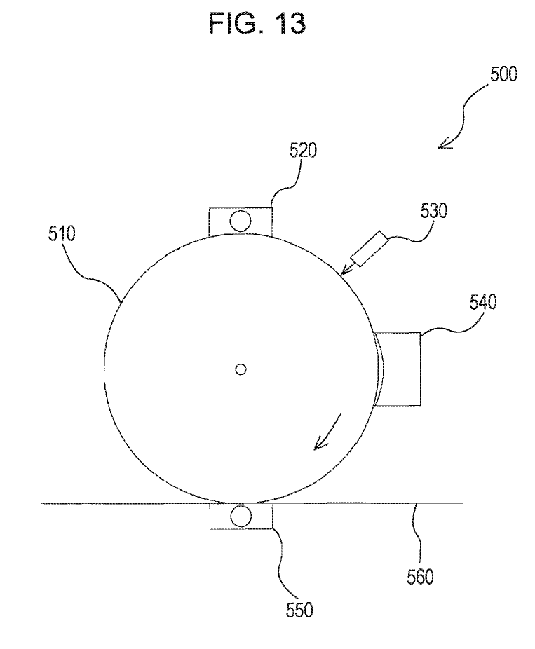

In the electro-optical module according to any one of the first to third embodiments, in a case where the common port is formed on the electro-optical panel as described above, the common port may be connected to common ports having the same polarity disposed on the wiring boards 20a and 20b through flexible flat cable (FFC) 280a to 280d as shown in FIG. 12. According to an electro-optical module 1C having such a construction, it is possible to supply a sufficient electric power to the light-emitting devices 12 without thick wires disposed on the flexible boards 30A or without new wires disposed on the flexible boards 30A. In addition, in FIG. 12, the common port 18 of the electro-optical panel 10C is connected to the common ports having the same polarity disposed on the wiring boards 20a and 20b through four FFCs 280a to 280d, but not limited thereto. For example, each of the common port 18 of the electro-optical panel 10C and the common ports of the wiring boards 20a and 20b may be connect to one FFC. Alternatively, the common port 18 of the electro-optical panel 10C and the common ports of the wiring boards 20a and 20b may be connected to a single one FFC.

Applications

As an electronic apparatus employing the aforementioned electro-optical modules, there are printers and scanner using light-emitting devices as light sources. In addition, the electro-optical modules may be employed by a search light or a flash lamp having high directionality and low power consumption.

The entire disclosure of Japanese Patent Application No. 2005-286410, filed Sep. 30, 2005 is expressly incorporated by reference herein.

What is claimed is:

1. An electro-optical module comprising:
an electro-optical panel provided with a light-emitting unit where a plurality of light-emitting devices are arrayed in a line shape;
two wiring boards which interpose the electro-optical panel and are disposed in a direction parallel to a longitudinal direction of the electro-optical panel;
a plurality of flexible boards which connect the electro-optical panel to the wiring boards; and
a driving circuit which is disposed in electro-optical panel or on the flexible boards and drives the light-emitting devices.

2. The electro-optical module according to claim 1,
wherein each of the light-emitting devices is disposed between a port connected to each of the light-emitting devices and a common port shared by a plurality of the light-emitting devices, and
wherein the common port is connected to a common port having the same polarity disposed on at least one wiring board.

3. The electro-optical module according to claim 1, wherein the flexible boards are divided into a plurality of the flexible boards.

4. The electro-optical module according to claim 1, further comprising a control board provided with a control circuit which controls the light-emitting devices through the driving circuits,
wherein one end of each flexible board is bent so as for each wiring board to overlap one side surface of the flexible board, and the other end of each flexible board is bent so as for each wiring board to constitute a wall surface substantially perpendicular to the electro-optical panel in an inner side of the flexible board, and
wherein the control board connecting the wiring boards is disposed between the wiring boards constitution the wall surface.

5. The electro-optical module according to claim 4, further comprising a case which has a receiving portion for receiving the wiring boards, the flexible boards, and the control board,
wherein the control board is provided with protrusions where an input port for inputting an external signals disposed, and
wherein openings through which the protrusions pass are provided to a bottom surface of the receiving portion of the case, and the wiring boards, the flexible boards, and the control board are received in the receiving portion in a state that the protrusions externally protrude from the openings.

6. The electro-optical module according to claim 1, wherein the light-emitting unit is constructed with a plurality of the light-emitting devices which are arrayed in a zigzag shape.

7. The electro-optical module according to claim 1, wherein the wiring boards are constructed by using a board having the same structure.

8. The electro-optical module according to claim 1, wherein the flexible boards are constructed by using a board having the same structure.

9. An electro-optical apparatus comprising the electro-optical module according to claim 1.

10. The electro-optical apparatus according to claim 9, wherein a condensing lens array is disposed on a light-emitting surface of the light-emitting unit.

11. An electronic apparatus comprising the electro-optical apparatus according to claim 9.
